(19) United States
(12) Patent Application Publication
(10) Pub. No.: US 2022/0002180 A1
(43) Pub. Date: Jan. 6, 2022

(54) GLASS PRODUCT AND METHOD FOR PRODUCING SAME

(71) Applicant: SCHOTT AG, Mainz (DE)

(72) Inventors: Kim Oliver Hofmann, Mainz-Kastel (DE); Thomas Pfeiffer, Ingelheim (DE); Olaf Claussen, Undenheim (DE); Ralf-Dieter Werner, Laufersweiler (DE); Dennis Perlitz, Vahlbruch (DE)

(73) Assignee: SCHOTT AG, Mainz (DE)

(21) Appl. No.: 17/368,728

(22) Filed: Jul. 6, 2021

(30) Foreign Application Priority Data
Jul. 2, 2020 (DE) 10 2020 117 532.9

(51) Int. Cl. C03B 7/098; C03C 3/091; C03C 3/089

(52) U.S. Cl. CPC C03B 7/098; C03C 3/089; C03C 3/091

(57) ABSTRACT

A method for producing a glass product, preferably a sheet-like glass product, is provided that includes conveying a molten silicate glass through a conduit system from one area of a glass product producing installation to another area of the glass product producing installation. The conduit system includes noble metal and is configured to conduct an electric current through the noble metal so as to generates Joule heat in the conduit system. The current is an alternating current for which the time integral over a positive and a negative half-wave results in a zero value.

### CROSS REFERENCE TO RELATED APPLICATIONS

This application claims benefit under 35 USC § 119 of German application 10 2020 117 532.9 filed Jul. 2, 2020, the entire contents of which are incorporated herein by reference.

### BACKGROUND

### 1. Field of the Invention

The present invention generally relates to a glass product and to a method for producing such a glass product.

### 2. Description of Related Art

In the manufacture of glass, in particular in the manufacture of a product made of or comprising glass, the molten glass is conveyed from the melting tank area to the shaping area through a conduit system. This conduit system must be kept at a constant temperature, by an appropriate configuration of heat-emitting parts, in order to provide, at a respective location, the temperature that is appropriate for the respective molten glass and the shaping process. Therefore, the conduit system usually has to be heated, in particular also in order to ensure, with the necessary production reliability, the respective viscosity that is required for the conveying processes of the molten glass.

For example, indirect heating techniques are known, using band heaters or else differently configured heat radiators which indirectly keep at temperature the glass conveying conduit system, through a heat conduction process.

Also known are direct heating techniques, where the walls of the glass conveying conduit system are heated by resistance heating, in which usually Joule heat is emitted to the glass.

Australian patent AU 473 784 B discloses a method for the manufacture of flat glass, in which the viscosity of glass to be hot-shaped is adjusted by electrical heating before it is shaped into a glass ribbon. To this end, an electric current is passed through the glass in order to control the temperature and flow of the glass. A drawback of such procedures is that this may induce bubble formation and electrochemical reactions.

DE 10 2016 107 577 A1 describes an apparatus and a method for producing glass products from a molten glass, in which the apparatus includes a crucible, e.g. a stirring crucible, and arranged therein a component such as a stirring member that is mounted for rotation for processing the molten glass, and wherein for heating the molten glass, the apparatus comprises an AC generator which powers the crucible or stirring crucible via electrical connection elements.

DE 10 2005 015 651 A1 generally discloses a method and a circuit arrangement for determining an impedance on an electrically heated glass melting tank as well as the use of such method and arrangement for producing glass. This publication also describes that the employed heating current is passed through the glass itself. The impedance measurement is used in order to detect the consumption of heating electrodes or of the palisade stones of the melting tank and to determine whether a platinum coated stirrer is making an eccentric stirring movement. Furthermore, the intension is to track down unwanted grounding in or on the glass melting tank, to calculate currents flowing between all the electrodes of the glass melting tank, and to calculate or identify direct current paths which can cause undesired bubble formation and corrosion.

International patent application WO 2020/023218 A1 describes a method for directly heating a metallic vessel in a glass making process. Multiple electrical heating circuits can be selected for the heating, which differ from one another in the phase angles, for example.

When heating current-carrying conduit elements, what is usually controlled in order to adjust the resulting heat is the applied voltage and the current flowing through the conduit system, and optionally the modulation of the alternating current. Modulation may be achieved by transformation or by pulse modulation with pulse groups, which may in particular be achieved through phase-fired control, also known as phase cutting or phase angle control. In terms of circuitry, this is usually implemented using transformers, transducers, or thyristors.

A general drawback of direct heating is that with the presence of electrical power, noble metal, and glass, electrochemical reactions are resulting, especially at the interface, which lead to glass defects in the product, such as bubbles and/or metallic particles, and/or to a decrease in optical transparency.

The disadvantage of indirect heating is that the heat conduction process introduces a time delay in the temperature control for the temperature of the glass in the conduit system.

### SUMMARY

In the case of direct heating, defects can occur when molten glass is conveyed on the way from the melting tank to the shaping area, and these defects may result from interactions between the molten glass and the refractory materials, for example. Typically, the molten glass is directed from the melting tank area to the shaping area through a conduit system made of or comprising noble metals, such as platinum or platinum alloys. For example, platinum can be alloyed with rhodium, iridium, and/or gold, and/or may additionally comprise zirconium dioxide and/or yttrium oxide for fine-grain stabilization. The advantage of using noble metal comprising components as the conduction materials is that these components are electrically conductive. Therefore, these components can be electrically heated by conducting preferably an alternating current through the component thereby generating Joule heat which heats the component.

However, it has been found that during the transfer of the molten glass, interactions may occur especially at the contact site between the component or components of the noble metal comprising conduit system and the molten glass. These interactions manifest themselves in the formation of defects such as bubbles or introduction of particles such as noble metal particles. This is disadvantageous because bubbles and/or particles will usually be objectionable for the respective addressed product and may lead to increased rejects.

This is particularly critical for special glasses with specific, often very high requirements on product quality. Especially for the production of very thin glass products, i.e. so-called ultra-thin glass or ultra-thin glass sheets, only a very small number of defects are permitted. Not only the absolute number of defects is significant, but also their type and size, depending on the specific requirements of the product. For example, very small particles might just be allowed, whereas larger particles will always lead to rejects, regardless of their number.

Hence, there is a need for glass products, in particular for thin glass or thin glass sheets which contain only a few defects such as bubbles and/or particles. There is also a need for a method for making such products.

The object of the invention encompasses the provision of glass products and methods for producing such glass products, which at least mitigate the deficiencies of prior art products and methods.

According to a first aspect, the invention generally relates to a glass product, in particular a sheet-like glass product, preferably with a thickness of at most 1100 μm and at least 15 μm, comprising a silicate glass, wherein the glass product includes less than 4 particles of a noble metal comprising material per kilogram of glass, preferably less than three particles of a noble metal comprising material per kilogram of glass, preferably with a size of the particles of less than 200 μm, size Gₚ of a particle referring to the greatest dimension in one spatial direction between portions of the particle (atoms or molecules). Thus, mean diameters of particles may be smaller than the size thereof as defined above.

In the context of the present disclosure, silicate glass is understood to mean a non-metallic glass with a high content of SiO₂, which has an SiO₂ content of at least 50 wt %, preferably at least 55 wt %, and most preferably of not more than 87 wt %, for example.

A molten silicate glass is understood to be a molten glass which comprises a silicate glass as defined in the preceding paragraph.

Glasses for making the presently disclosed glass products include, for example, the groups of borosilicate (BS), aluminosilicate (AS), or boro-aluminosilicate glasses, or lithium aluminum silicate glass ceramics (LAS), which are mentioned here by way of example, without losing the generality.

The glass product according to one embodiment comprises a glass comprising at least 50 wt % SiO₂ and preferably at most 87 wt % SiO₂.

According to a variant of the glass product, the glass furthermore contains the constituent Al₂O₃ in addition to the constituent SiO₂, preferably up to a content of at most 25 wt %, and most preferably in particular at least 3 wt %, while the glass can furthermore contain B₂O₃.

According to another variant of the glass product, the glass furthermore contains the constituent B₂O₃ in addition to the constituent SiO₂, preferably at least 5 wt % and most preferably not more than 25 wt % thereof, while the glass can furthermore contain Al₂O₃.

A glass that can be used as an Li—Al—Si glass in particular has an Li₂O content from 4.6 wt % to 5.4 wt %, and an Na₂O content from 8.1 wt % to 9.7% wt %, and an Al₂O₃ content from 16 wt % to 20 wt %.

A Li—Al—Si glass with a composition comprising 3.0 to 4.2 wt % of Li₂O, 19 to 23 wt % of Al₂O₃, 60 to 69 wt % of SiO₂ as well as TiO₂ and ZrO₂ can be used as a glass that is ceramizable into a glass ceramic, also referred to as green glass.

A glass containing the following constituents (in wt %) can be used as a borosilicate glass:

SiO₂ 70-87

B₂O₃ 7-25

Na₂O+K₂O 0.5-9

Al₂O₃ 0-7

CaO 0-3.

A glass in particular with the following composition can also be used as the borosilicate glass:

SiO₂ 70-86 wt %

Al₂O₃ 0-5 wt %

B₂O₃ 9.0-25 wt %

Na₂O 0.5-5.0 wt %

K₂O 0-1.0 wt %

Li₂O 0-1.0 wt %;

or else a glass, in particular an alkali borosilicate glass, which contains

SiO₂ 78.3-81.0 wt %

B₂O₃ 9.0-13.0 wt %

Al₂O₃ 3.5-5.3 wt %

Na₂O 3.5-6.5 wt %

K₂O 0.3-2.0 wt %

CaO 0.0-2.0 wt %;

or else a glass, in particular an alkali borosilicate glass, which comprises the following constituents, in wt %:

SiO₂ 55 to 85

B₂O₃ 3 to 20

Al₂O₃ 0 to 15

Na₂O 3 to 15

K₂O 3 to 15

ZnO 0 to 12

TiO₂ 0.5 to 10

CaO 0 to 0.1.

A glass with the following composition, in wt %, can be used as an alkali-free alkaline earth silicate glass, for example:

SiO₂ 58 to 65

B₂O₃ 6 to 10.5

Al₂O₃ 14 to 25

MgO 0 to 3

CaO 0 to 9

BaO 3 to 8

ZnO 0 to 2,

with the proviso that the total of the MgO, CaO, and BaO contents thereof is characterized by ranging from 8 to 18 wt %.

A silicate glass for making the presently disclosed glass products may furthermore comprise the following constituents, in wt %, on an oxide basis:

SiO₂ 50 to 65, preferably 55 to 65

Al₂O₃ 15 to 20

B₂O₃ 0 to 6

Li₂O 0 to 6

Na₂O 8 to 16

K₂O 0 to 5

MgO 0 to 5

CaO 0 to 7, preferably 0 to 1

ZnO 0 to 4, preferably 0 to 1

ZrO₂ 0 to 4

TiO₂ 0 to 1, preferably substantially free of TiO₂.

Furthermore, the glass may contain from 0 to 1 wt % of P₂O₅, SrO, BaO, and also 0 to 1 wt % of refining agents SnO₂, CeO₂, or As₂O₃ or other refining agents, and optionally other constituents, for example fluorine.

According to a second aspect, the invention generally relates to a glass product, in particular a sheet-like glass product, preferably with a thickness of at most 1100 μm and at least 15 μm, which comprises a silicate glass, wherein the glass product has less than 3 bubbles per kilogram of glass, preferably with a size of the bubbles of less than 200 μm, size of the bubble referring to the greatest distance within the bubble in any spatial direction. Thus, mean diameters of bubbles may be smaller than the size thereof as defined above.

This is advantageous, because particles and/or bubbles, in particular noble metal comprising particles, are glass defects that may lead to rejects. Whether a glass product that includes a glass defect such as a particle or a bubble is rejected or is still acceptable for a particular application is a question of the incidence of the glass defect, i.e. the frequency of occurrence of such a defect, and the latter is usually specified per unit weight of glass, which means it is also a question of the size of the glass defect. For example, glass defects above a certain size always lead to rejects, but smaller glass defects may still be uncritical for a particular application of a glass product, provided the glass defects are small enough and there are not too many of them appearing.

Especially for special glasses, the requirements in this respect are constantly increasing. Therefore, there is a continuous need to provide glass products with only a very low amount of defects, especially in order to be able to continue cost-efficient manufacture in very demanding product fields.

Such glass products with improved product quality, namely reduced frequency of occurrence of particles and/or bubbles and/or with only small glass defects such as particles and/or bubbles can be produced in a surprisingly simple way by a method for producing a glass product according to yet another aspect of the present disclosure.

In fact, it has been found that the type, quantity, and/or size of the defects that occur can be influenced by the manner of current conduction within the noble metal comprising component(s) which are in contact with a molten glass.

Furthermore, advantageously, it has been found that with the method according to the present disclosure it is also possible to dispense with constituents in the glass composition that are critical with regard to the stability and durability of a noble metal comprising component.

For example, the method according to embodiments advantageously permits to melt glasses without using SnO₂ as a refining agent. It is in particular possible to perform refining using table salt, for example. Therefore, more generally, without being limited to the embodiments of a glass product as mentioned above, the glass product may comprise a glass which comprises at most 2500 ppm, preferably 2000 ppm, more preferred at most 1000 ppm and even more preferred at most 500 ppm of SnO₂, based on the weight in each case. In other words, the glass product can generally comprise a glass that contains SnO₂ only in the form of unavoidable impurities. The glass product may further generally comprise a glass comprising chloride, and preferably at least ** 100 ppm and up to ** 2500 ppm thereof, based on the weight in each case.

In other words, such an embodiment of the glass product is advantageous, since in this way the glass product comprises a glass which can be melted with a gentler refining agent, which in particular attacks noble metal comprising components to a much less severe degree and therefore advantageously can contribute or contributes to a reduction in particle formation and/or bubble formation.

The electrochemical reactions are generally dependent on the current density at the site of the reaction.

Accordingly, the invention discloses a method for producing a glass product, preferably a sheet-like glass product, in which a silicate molten glass is conveyed through a noble metal comprising conduit system from one area of a glass product producing installation to another area of a glass product producing installation, and wherein the noble metal comprising conduit system is current carrying in such a way that an electric current conducted through the noble metal generates Joule heat in the noble metal comprising conduit system, in particular within the noble metal, the current being an alternating current for which the time integral over a positive and a negative half-wave substantially results in a zero value. This also means that, in a time average, the direct current component of the current used to generate Joule heat assumes the zero value already over one full wave.

The conduit system according to the invention is preferably used only for transporting and, if necessary, for tempering the silicate glass melt during this transport, but not for further functions such as refining or homogenizing.

In the context of the present disclosure, a noble metal comprising conduit system is understood to mean that the conduit system may, for instance, be made predominantly, i.e. at least 50 wt % thereof, or substantially, i.e. at least 90 wt % thereof, or else entirely of noble metal or of an alloy comprising at least one noble metal, for example also a noble metal alloy. However, other configurations are conceivable as well. Within the scope of the present disclosure, a noble metal comprising conduit system may, for example, also be configured such that the conduit system has a coating provided on its inner surface, for example in a conduit element such as a tubular conduit system, which coating comprises at least one noble metal.

Thus, in contrast to the prior art, not only are the time-averaged current densities taken into account, but essentially all current densities flowing at any point in time. This is surprising, and it has not been mentioned in any publication that a pulse modulation has an influence on the formation of defects.

First, this is particularly surprising when the conduit system comprises a substantially tubular conduit element which has a noble metal comprising coating on its inner surface and in which the alternating current is carried essentially in the longitudinal direction of the tubular conduit element because in this case it could also be assumed that the alternating current is entirely conducted within the noble metal and the space outside the noble metal is potential-free, so that the shape of the voltage and current profiles should only have a minor influence on defects in the glass.

In a preferred embodiment, the alternating current is substantially sinusoidal and includes only a single basic frequency ω₀ and substantially no other frequency components.

In preferred embodiments, the deviation of the time integral of the alternating current signal over a full wave from the time integral of an ideal sinusoidal pulse signal curve is less than 10%, preferably less than 5%, and most preferably less than 2%.

In a further, particularly preferred method for producing a glass product, preferably a sheet-like glass product, a silicate molten glass is conveyed through a noble metal comprising conduit system from one area of a glass product producing installation to another area of the glass product producing installation, and the noble metal comprising conduit system is current carrying such that an electric current conducted through the noble metal generates Joule heat in the noble metal comprising conduit system, in particular within the noble metal, and wherein the phase angle θ₀ between current and voltage is measured at the basic frequency ω₀.

This measurement of the basic frequency ω₀, at which the phase angle θ₀ between current and voltage is measured, is preferably performed at least once for each glass of a silicate molten glass that is used for the presently disclosed method, and this prior to or at the start of the process in each case. Although in principle it is sufficient to measure the basic frequency ω₀ only at the value or infinitesimally close to the value at which the phase angle θ₀ between current and voltage as a function of the frequency ω₀ is at a local minimum, or to measure it at points at which the phase angle θ₀ between current and voltage is less than ±10°, preferably less than ±5°, and most preferably less than ±2°, it has nevertheless proven to be advantageous to measure or tune the basic frequency preferably in a range from about 4*10⁻² Hz to about 10⁶ Hz in order to be able to identify the respective previously mentioned ranges of the phase angle with higher process reliability.

In this way, the angle θ is obtained for the respective glass, at which the phase angle θ₀ between current and voltage as a function of frequency is at a local minimum, that is at which the local derivative of the phase angle θ with respect to frequency ω assumes the zero value, and furthermore those ranges are obtained in which the phase angle θ₀ between current and voltage is less than ±10°, preferably less than ±5°, and most preferably less than ±2°.

Here, the wording that the phase angle θ₀ between current and voltage at the basic frequency ω₀ is measured at least once for the silicate molten glass furthermore means that the measured values of the phase angle θ₀ between current and voltage as a function of frequency ω are then given for each silicate molten glass which is used in the presently disclosed method. As long as the composition of the molten glass remains unchanged, this measurement can then be retained for the settings of the basic frequency ω₀ as described below, in particular also retained for further implementations of the method, without need to again measure this phase angle θ₀.

However, if the composition of the molten silicate is changed, which means, for example, that the constituents thereof are changed, the measurement of the phase angle θ₀ between current and voltage at the basic frequency ω₀ as described above is preferably repeated at least once for the silicate molten glass with the changed composition of the glass. Then, provided the changed composition of the molten silicate is retained, the measured values obtained in this way can again be used as long as the changed composition of the molten silicate remains unchanged. A change in the composition of the glass of the molten siclicate is understood to mean a change in the composition in which at least one constituent of the glass of the molten silicate is changed by more than +/−0.5 wt %.

Based on the measurements described above, the basic frequency ω₀ is then advantageously adjusted based on the phase angle θ₀ between current and voltage for the further implementation of the method.

Particularly preferably, the basic frequency ω₀ is adjusted such that the phase angle θ₀ between current and voltage as a function of frequency is at a local minimum at which the local derivative of the phase angle θ with respect to frequency ω assumes a zero value.

Besides this optimum and preferred setting, the phase angle θ₀ between current and voltage may also be smaller than ±10°, preferably smaller than ±5°, and most preferably smaller than ±2° during the implementation of the method. In the sense of this immediately preceding statement, the term phase angle θ₀ means that the subscript “0” indicates that this phase angle θ₀ is not only given at the frequency for which the derivative of the phase angle θ with respect to frequency ω is at a minimum, but may be within the preferred range of phase angles θ between current and voltage of less than ±10°, preferably less than ±5°, and most preferably less than ±2°, and in the context of the present disclosure these phase angles θ₀ are accordingly also referred to as minimized phase angles.

Similarly, when specifying the frequency ω, the subscript “0” means that the frequency ω₀ is a frequency at which a minimized phase angle θ₀ in the sense of the above definition is given.

In the embodiments presently described, it is also possible to use time-dependent, in particular time-periodic voltages with a voltage curve U(ω) which generates the alternating current used in the method disclosed herein, with signal components that include more than one discrete frequency ω, i.e., for example, the discrete frequencies ω₁, ω₂, ω₃, . . . ωₙ, wherein n is a non-zero natural number, and wherein the overall voltage curve U(ω) resulting from the superposition of the individual signal components results as follows:

U(ω)=U₁(ω₁)+U₂(ω₂)+U₃(ω₃)+ . . . Uₙ(ωₙ).

Here, each of U₁(ω₁), U₂(ω₂), U₃(ω₃) . . . Uₙ(ωₙ) is a respective voltage signal with a sinusoidal or cosinusoidal shape with the respective frequency ω₁, ω₂, ω₃, . . . ωₙ. Such signals can be generated with a sine wave generator, superimposed correspondingly, and then optionally amplified, as required depending on the application.

For voltage curves with a plurality of discrete frequency components, too, each of the discrete frequency components with ω₁, ω₂, ω₃, . . . ωₙ meets the following condition as given above for the basic frequency ω₀, namely that for each of these frequency components with ω₁, ω₂, ω₃, . . . ωₙ the phase angle θ₁(ω₁), θ₂(ω₂), θ₃(ω₃), . . . θₙ(ωₙ) at the respective frequency is less than ±10°, preferably less than ±5°, and most preferably less than ±2° in each case.

In a further embodiment, it is also possible to use time-dependent, in particular time-periodic voltages with a voltage curve U(ω) generating the alternating current as used in the method presently disclosed, which comprises signal components with a continuous spectrum of sinusoidal or cosinusoidal signal components Ui(ωi) with different frequency components ωᵢ from the spectral range or frequency interval from ωₓ to ω_{y}, wherein the following applies for the frequency ωᵢ of each of these signal components:

ωₓ<ωᵢ<ω_{y}

wherein ωₓ is the frequency at which a phase angle θ between current and voltage is −10°, and ω_{y} is the frequency at which a phase angle θ between current and voltage is +10°.

Signals with such frequency components may be generated using a noise generator, for example, which essentially provides white noise as an output voltage signal, and the output voltage signal thereof is then filtered using a bandpass filter having a passband that allows to pass frequencies within an interval from approximately ωx to approximately ωy. A so obtained signal may then be further amplified, depending on the specific application.

For the presently disclosed glasses, the basic frequency ω₀ is at least 5*10² Hz, preferably at least 1*10³ Hz, and ranges up to at most 2*10⁴ Hz, preferably at most 1.5*10⁴ Hz, but for the temperature ranges of the molten silicate presently disclosed, without loss of generality. Similarly, the frequencies ω₁, ω₂, ω₃, . . . ωₙ and ωᵢ lie within the interval between at least 5*10² Hz, preferably at least 1*10³ Hz, and up to at most 2*10⁴ Hz, preferably up to at most 1.5*10⁴ Hz.

Preferably, further components of the voltage curve U(ω) which have frequency components that are smaller than ωₓ on average over time of the absolute value of these frequency components, amount to less than 15%, preferably less than 5%, and most preferably less than 3% of the time-averaged value of the absolute value of the voltage curve U(ω).

Furthermore preferably, further components of the voltage curve U(ω) which have frequency components that are greater than ω_{y} on average over time of the absolute value of these frequency components, such as harmonics, amount to less than 15%, preferably less than 5%, and most preferably less than 3% of the time-averaged value of the absolute value of the voltage curve U(ω).

Surprisingly, it has been found that such a process control, also referred to as process control with minimized phase angle, allows to obtain glass products with significantly lower numbers of particles and/or bubbles than with conventional resistance heating of the noble metal comprising component.

Without wishing to be bound by any particular theory, it is believed that this effect is attributable to the fact that when the phase angle is minimized, the charge carriers in the noble metal comprising component are better able to follow the alternating current signal or the movement of positive charge carriers is balanced out with the movement of negative charge carriers and this leads to low loads on the noble metal comprising component, with the result of improving the mechanical stability thereof. This then results in the observed lower particle introduction into the glass product.

In the presently disclosed method, the temperature of the molten glass was between 1200° C. and 1500° C. Under production conditions, temperatures of the molten glass between 1000° C. and 1650° C. are conceivable.

With the presently disclosed method, a glass product is produced or producible, in particular a sheet-like glass product, which has a thickness of at most 1100 μm and at least 15 μm, comprising a silicate glass, which glass product includes less than four particles of a noble metal comprising material per kilogram of glass, preferably less than three particles of a noble metal comprising material per kilogram of glass, preferably with a size of the particles of less than 200 μm.

With the presently disclosed method, a glass product is produced or producible, in particular a sheet-like glass product, which has a thickness of at most 1100 μm and at least 15 μm, comprising a silicate glass, which glass product includes less than 3 bubbles per kilogram of glass, preferably with a size of the bubbles of less than 200 μm.

In the context of the present disclosure, the following definitions shall apply.

In the context of the present disclosure, a metal referred to as a noble metal is one selected from the following list: platinum, rhodium, iridium, osmium, rhenium, ruthenium, palladium, gold, silver, and alloys of these metals.

In the context of the present disclosure, a component is referred to as a noble metal comprising component if it comprises at least one metal from the above list in a significant amount, i.e. with a content that exceeds unavoidable traces, in particular at least 0.1 wt %, preferably at least 1 wt %, particularly preferably at least 5 wt %. This in particular also includes a component which is predominantly composed of at least one noble metal or a mixture of noble metals or an alloy consisting of one or more noble metals, that is to say more than 50 wt % thereof, or substantially, that is to say more than 90 wt % thereof, or even entirely. A typically alloy used is PtIr1 and/or PtIr5, for example, that is a platinum alloy with a content of 1 wt % of iridium or 5 wt % of iridium, respectively.

The types of molten glass of the present invention comprise oxidic molten glass, in particular silicon-containing oxidic molten glass, and consequently silicate molten glass.

In the context of the present disclosure, glass is understood to mean an amorphous material which is obtainable in a melting process. Glass product is understood to mean a product (or article) which comprises the material glass, which may in particular be predominantly made of glass, that is to say more than 50 wt % thereof, or substantially, that is to say more than 90 wt % thereof, or even entirely.

In the context of the present disclosure, sheet-like product is understood to mean a product which has a lateral dimension in a first spatial direction of a Cartesian coordinate system that is at least one order of magnitude smaller than in the other two spatial directions perpendicular to the first spatial direction. This first spatial direction can also be understood as the thickness of the product, the two further spatial directions as the length and width of the product. In other words, in a sheet-like product, the thickness is at least one order of magnitude smaller than the length and width thereof.

In the context of the present disclosure, bubble is understood to mean a fluid-filled, usually gas-filled cavity in a material and/or in a product. A bubble may be closed, that is enclosed in every direction by the material, for example the material of a product made of that material, or it may be open, for example if the bubble is located on the edge of the product and in this case is not completely enclosed by the material the product is made of or the material encompassed in a product.

In the context of the present disclosure, particle is understood to mean in particular a particle made of or at least comprising a noble metal. In particular, particles may comprise platinum or a platinum alloy or may consist of platinum or a platinum alloy. The particles may differ in their morphology. For example spherical particles are possible, that is particles with an at least approximately spherical shape, but needle-like or needle-shaped particles or rods are possible as well. The dimensions of the particles may be in a range of up to 100 μm; typical dimensions of the particles are up to about 30 μm. As already defined above, the dimensions specified in the context of the present disclosure relate to the respective maximum lateral dimension of the respective particle or of the respective bubble. Thus, in the case of a needle-shaped particle, the specified size is the length in the direction of the longest extent of the particle.

A glass product producing installation is understood to mean an apparatus in which the typical process steps for producing glass and products made of glass are performed or can be performed. The typical process steps include providing and melting a glass batch, refining, conditioning, and hot forming. Area of such an installation is understood to mean sections of the apparatus in which particular process steps are performed, and these areas are spatially separated from other areas of the apparatus so that, for example, transfer or conveyor means may be provided between one area of the apparatus and a further one. Such conveyor means in which the molten glass is transferred from one area of the installation to another area are also referred to as a conduit element or conduit system in the context of the present disclosure. Such a conduit element or conduit system may also be referred to as a channel. Typical areas of a glass product producing installation include the refining chamber or the working tank, for example. More particularly, the glass product producing apparatus may include a so-called melting tank in which the batch is melted, for example, a refining tank in which the molten glass is refined, and a holding tank or working tank in which conditioning is conducted. Homogenization usually occurs in a stirring section where the molten glass is homogenized by a stirring rod.

Such optimized process control with minimized phase angle can be implemented by amplitude modulation, for example. Usually, thyristor controllers are used to generate the alternating current for directly heating a conduit system that conveys a molten glass. If those are retained, it is possible to achieve a nearly sinusoidal or at least sinusoidal-like pulse signal curve by using a further circuit which blurs the phase cuttings such that an at least partially sinusoidal signal curve is obtained.

In this case, the circuit may, for example, include a further variable transformer on the primary side, in addition to the thyristors that are connected in anti-parallel manner. This makes it possible to reduce the voltage on the primary side as far as necessary to the operating point, so that the further phase cuts are slight and the shape of the signal curve no longer exhibits any or at least only very slight discontinuities and is therefore significantly more sinusoidal.

Furthermore preferably, according to one embodiment of the method, the harmonic component of the time-averaged absolute value of the pulse signal curve is less than 15%, preferably less than 5%, and most preferably less than 3%.

### BRIEF DESCRIPTION OF THE DRAWINGS

The invention will now be further explained with reference to drawings, in which

FIG. 1 is a schematic diagram of an experimental setup;

FIGS. 2a-2c and 3a-3c show photographs of silicate molten glass from an experimental setup according to FIG. 1;

FIG. 4 shows a schematic diagram of a further experimental setup for electrochemical impedance spectroscopy; and

FIG. 5 shows an impedance spectrum from an experimental setup according to FIG. 4, showing the absolute value of complex impedance Z as a function of frequency ω;

FIG. 6 shows an impedance spectrum from an experimental setup according to FIG. 4, showing the phase angle θ as a function of frequency ω;

FIG. 7 shows a substantially tubular conduit element of a conduit system, which has a coating comprising at least one noble metal on its inner surface and in which an alternating current is passed through the noble metal using a generator G;

FIG. 8 shows an oscilloscope image displaying a periodic voltage curve as a function of time, this voltage curve exhibiting a strong deviation from a sinusoidal shape, which is essentially caused by phase cutting;

FIG. 9 shows an oscilloscope image displaying a periodic voltage curve as a function of time, this voltage curve exhibiting only a very small deviation from a sinusoidal shape;

FIG. 10 illustrates the introduction of particulate matter into a molten glass under various forms of alternating current which is used for heating a molten glass located in a noble metal comprising conduit element;

FIG. 11 shows an oscilloscope image displaying a voltage curve for explaining the current flow during time T₁ of FIG. 10;

FIG. 12 shows an oscilloscope image displaying a periodic voltage curve for explaining the current flow during time T₃ of FIG. 10;

FIG. 13 shows a basic circuit diagram of an exemplary circuit arrangement; and

FIGS. 14 and 15 are exemplary scanning electron micrographs of noble metal comprising particles;

FIG. 16 shows a further, essentially tubular conduit element of a conduit system, which has a coating comprising at least one noble metal on its inner surface and in which a generator G passes an alternating current through the noble metal of a respective section out of three sections which are designated overflow 0 (OF0), overflow 1 (OF1), overflow 2 (OF2).

### DETAILED DESCRIPTION

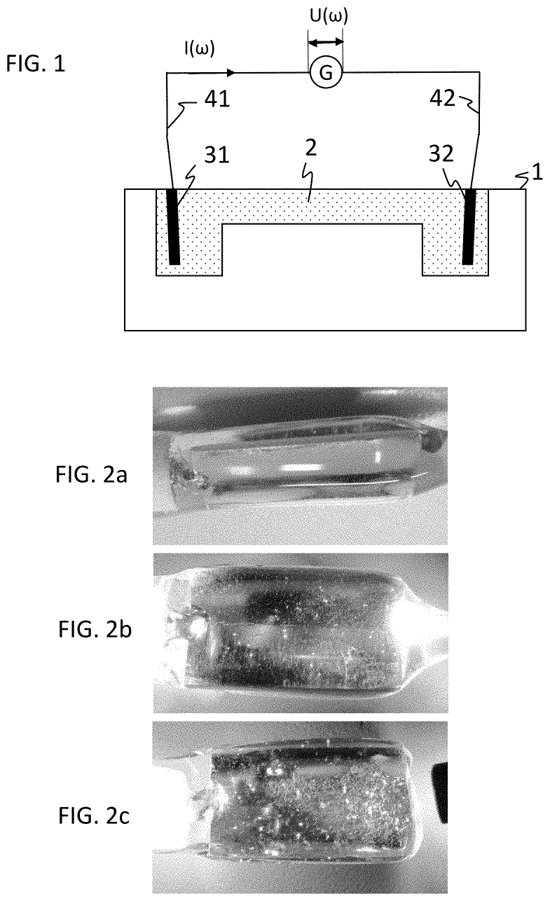

FIG. 1 shows a schematic diagram of an experimental set-up, not drawn to scale, for determining the influence of pulse modulation in the generation of the alternating current I(ω) in a silicate molten glass. A silicate molten glass 2 is melted in a crucible made of a refractory material comprising SiO₂, for example a so-called QUARZAL® crucible.

Two noble metal comprising electrodes 31, 32 of the same size, with a surface area of 0.5 cm by 1 cm, were each embedded in a respective half of the crucible 1. The crucible halves are connected via a bridge of molten glass, which means that the current I(ω) flowing between electrodes 31, 32 is entirely conducted through the molten glass 2. The respective electrode 31, 32 is made of a noble metal alloy, by way of example, namely an alloy of platinum and rhodium, which may also be referred to as “PtRh10”, that is 10 wt % of rhodium and 90 wt % of platinum. The molten glass 2 was a molten silicate glass.

The space surrounding the crucible 1 is flushed with inert gas (here argon) in order to prevent a gas-phase transport reaction with respect to the noble metal comprising electrodes 31, 32.

The crucible 1 is brought to a temperature of 1450° C., for example, in a furnace.

Then, between the electrodes 31, 32, the signal shape of the current I(ω) flowing between the two electrodes 31, 32 was varied using different modulators within the generator G which represents an alternating current source, under the boundary condition to have a geometric time-averaged current density of 25 mA/cm² flowing between the electrodes 31, 32 in each of the tests.

Three tests were conducted, as will be described in more detail below, during which the two electrodes 31, 32 were exposed to the modulation and to molten glass contact for 24 hours.

After the holding time of 24 hours, one of the electrodes 31, 32 was removed from the crucible half and quickly frozen with the glass attached. Photographs thereof can be seen in FIGS. 2a to 2c.

In FIG. 2a it can be seen that with currentless heating and with an at least approximately sinusoidal signal curve in FIG. 2b, the noble metal of the electrode and the structure of the respective electrodes do not exhibit changes in grain structure.

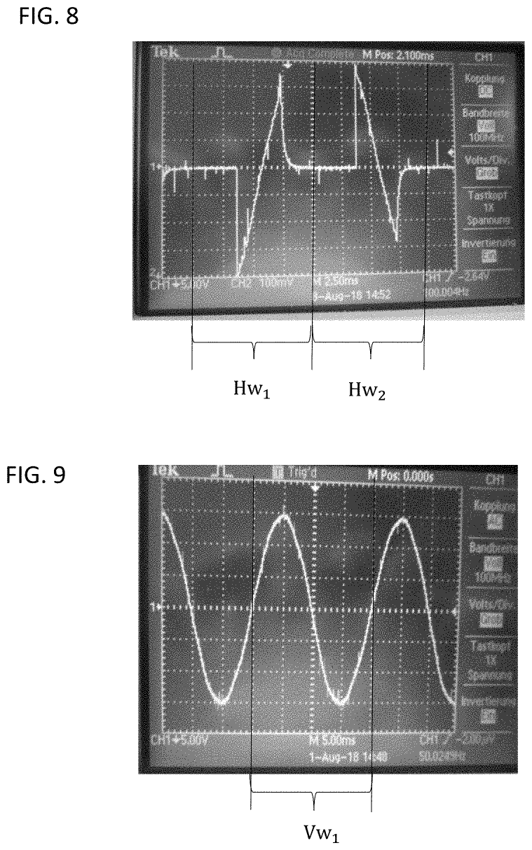

FIG. 9 shows an exemplary oscilloscope image with a periodic voltage curve U(ω) displayed thereon, as a function of time at a basic frequency ω₀, and this voltage curve only exhibits a very small deviation from a sinusoidal shape and represents the shape of the alternating current I(ω). Here, an exemplary sinusoidal full wave is denoted as interval Vω₁. The basic frequency ω₀was 50 Hz, by way of example.

However, when phase cutting is employed for generating the alternating current I(ω), for example using a thyristor as in FIG. 2c, a clear change in the reflection properties of the coarse-grain noble metal crystals can be seen, so that it can be concluded that a chemical reaction has occurred.

FIG. 8 shows an exemplary oscilloscope image with a periodic voltage curve U(ω) displayed thereon, as a function of time at a basic frequency ω₀, and this voltage curve shows a strong deviation from a sinusoidal shape, which is essentially caused by phase cutting and represents the shape of the alternating current I(ω) used here. The basic frequency ω₀was 50 Hz, by way of example. Here, an exemplary first, non-sinusoidal half-wave generated by phase cutting is denoted as interval Hω₁, and a second non-sinusoidal half-wave generated by phase cutting is denoted as interval Hω₂.

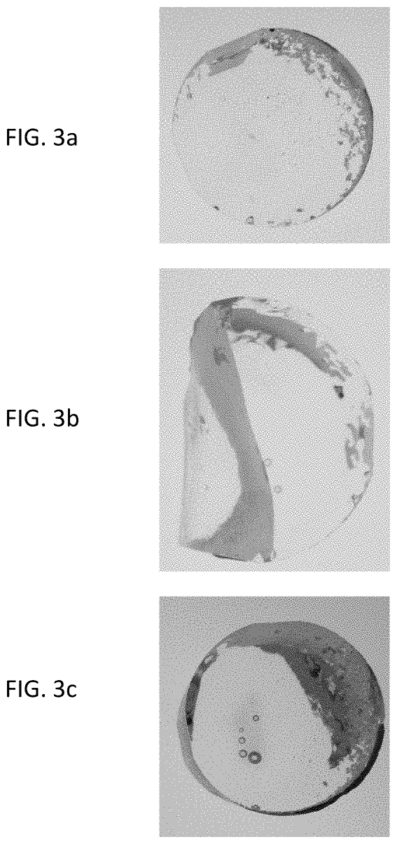

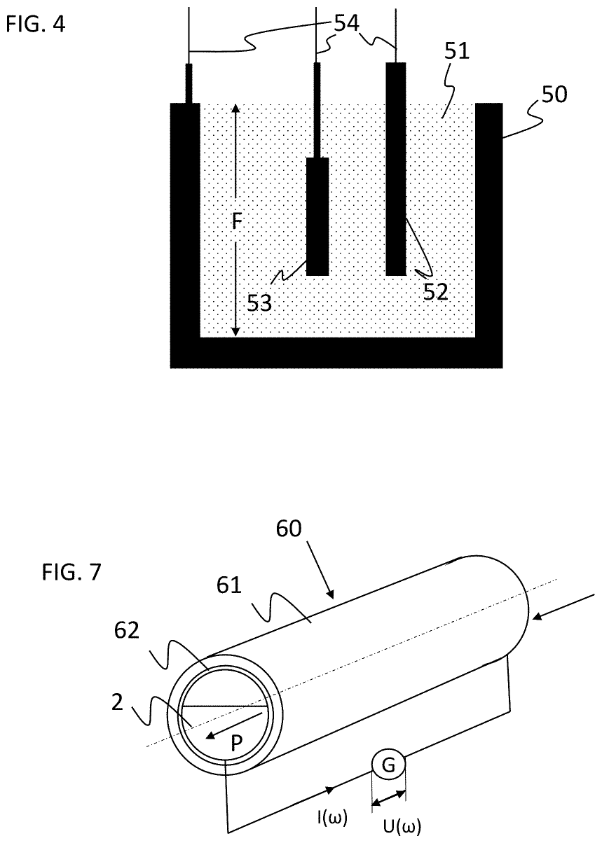

Once the entire crucible 1 had been tempered down, the glass body of the crucible half, from which the corresponding electrode was previously removed, was drilled out and the base was polished. The images of the samples taken in transmitted light are shown in FIGS. 3a to 3c.

It can be clearly seen that no bubbles are visible in the case of a currentless signal curve in FIG. 3a, and that only very few bubbles have arisen with an at least approximately sinusoidal signal curve in FIG. 3b.

However, if phase cutting by a thyristor as in FIG. 3c is employed, not only significant bubble formation can be observed, but also darkening of the glass around the bubbles formed, which can be attributed to the formation of noble metal particles.

In the further processes, the inventors used electrochemical impedance spectroscopy in order to be able to identify properties of the respective employed glass in more detail.

A schematic experimental setup for electrochemical impedance spectroscopy is shown in FIG. 4. Here, glass was melted in a platinum crucible 50 with a diameter of about 10 cm, and the filling height F of the silicate molten glass 51 was about 10 cm. The crucible 51 was kept at temperature in an oven, and the electrode was introduced into the molten glass 51 to be examined, in the present case a rectangular platinum electrode 53 with a size of approximately 2×4 cm.

Both the crucible 51 and the electrodes 52, 53 are electrically addressable, through a respective platinum wire 54. Furthermore, an O₂|Pt|ZrO₂ reference electrode 52 (rinsed with 1 bar of O₂ as a reference) was introduced into the molten glass 51 in order to have an independent reference potential for the electrochemical measurements.

The electrochemical impedance spectrometer was connected in the following configuration:

The working electrode 53 is the platinum electrode under test, the reference electrode 52 is the introduced O₂|Pt|ZrO₂ reference electrode, the counter electrode is defined by the crucible 51.

The impedance spectra were recorded by potentiostatic electrochemical impedance spectroscopy, and an excitation potential of 25 mV was selected.

The following impedance spectra were recorded of a molten glass 51 of a composition corresponding to AS87 glass, at frequencies from 10⁶ Hz to 5*10⁻³ Hz at melting temperatures 1200° C., 1300° C., 1400° C., 1500° C.

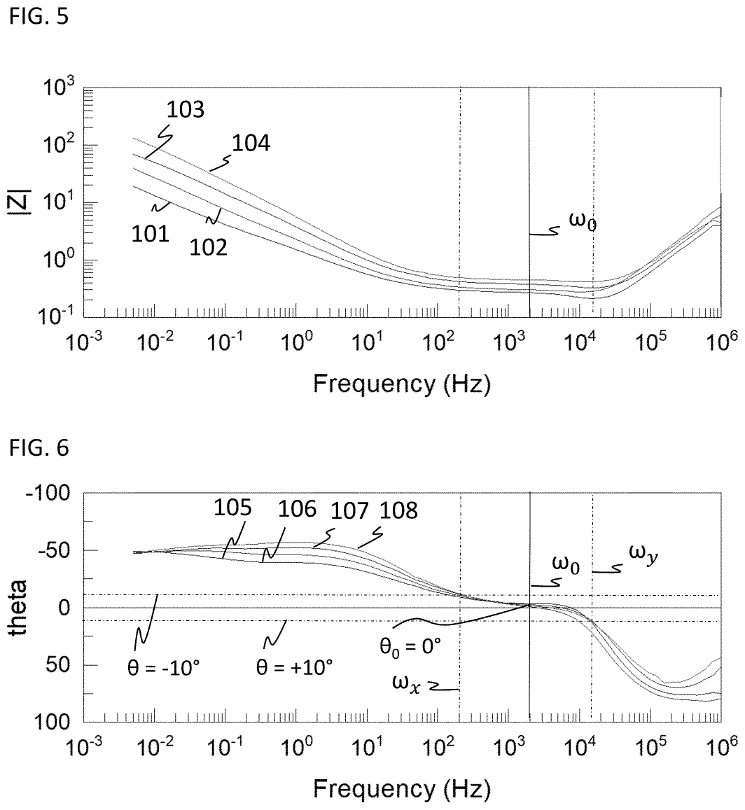

Merely by way of example, the current generated in this case is designated as I(ω), and the voltage occurring here as U(ω). The complex impedance is resulting here as a function of frequency, as Z(ω)=U(ω)/I(ω), the absolute value |Z| of which is shown in the impedance spectrogram of FIG. 5 for different temperatures.

The frequency-dependent phase angle θ(ω) between current I(ω) and voltage U(ω), which is denoted by “theta” in FIG. 6, showed a clear frequency dependency with a pronounced minimum, and the exploitation thereof with respect to the method will be described in more detail below.

These tests are intended for simulating an arrangement such as that shown in FIG. 7 and in particular the interaction of the noble metal, in particular of a noble metal comprising conduit system, with the molten silicate.

Surprisingly it has been found that the test results obtained with the arrangements shown in FIGS. 1 and 4 were substantially also transferable to other embodiments, such as, for example, to the embodiment shown in FIG. 7 in which substantially no current was passed directly through the molten silicate or molten glass 2, rather it was passed substantially through the noble metal comprising zone, that is through the coating or lining 62 that will be described in more detail below. Although this positive effect does not seem to be fully understood, one reason for the transferability of the present results may be the skin effect of an alternating-frequency current in a conductor, according to which higher current densities occur near the surface of a conductor than in the interior thereof in the case of alternating-frequency currents, since the conductor tries to remain free of fields and voltage inside. These higher current densities occurring near the surface of the respective conductor are therefore in direct contact with the molten glass 2 adjoining the conductor 62.

FIG. 7 shows a substantially tubular conduit element 60 of a conduit system for conveying a molten glass. This conduit system may extend between a melting unit and a device for hot forming, for example.

The conduit element 60 comprises a tubular section 61 made of a refractory material and has, on its inner surface, a coating 62 comprising at least one noble metal, or a noble metal comprising lining 62.

As mentioned above, this noble metal may for example comprise platinum or platinum alloys. For example, platinum may be alloyed with rhodium, iridium and gold, and/or may additionally comprise zirconium dioxide and/or yttrium oxide for fine-grain stabilization.

The generator G is used to pass the alternating current I(ω) through the noble metal, whereby the alternating voltage U(ω) is generated at the generator, as shown in FIGS. 8 and 9.

The basic frequency ω₀ was set based on the phase angle θ₀ between current and voltage.

The basic frequency ω₀ was in particular set such that the phase angle θ₀ between current and voltage as a function of frequency ω is at a local minimum where the local derivative of the phase angle θ with respect to frequency ω assumes a zero value.

Such a minimum can be seen in the graph of FIG. 6 for the value of frequency ω₀, by way of example.

However, depending on how the process was conducted, this minimum was not sharply localized, with a pronounced peak, but rather was within a range with a low slope. For the presently disclosed embodiments, an angular range with such a low slope, in which the phase angle θ₀ between current and voltage is less than ±10°, preferably less than ±5°, and most preferably less than ±2° has proven to be advantageous as well.

Generally, as can be seen from the view of FIG. 6, for example, for the glasses disclosed in the present invention, in a temperature range from 1000° C. to 1650° C. and for a phase angle θ₀ between current and voltage of less than ±10°, the basic frequency ω₀ was preferably at least about 2*10² Hz to 5*10² Hz at a phase angle θ₀ of −10° between current and voltage, corresponding to ωₓ, and ranged to at most about 1.5*10⁴ Hz to 2*10⁴ Hz, corresponding to ω_{y}, at a phase angle θ₀ of +10° between current and voltage.

Although the arrangement shown in FIG. 7 essentially only comprises currents I(ω) which flow in the direction of arrow P within the molten glass 2, it has been found, as already stated above, that the results obtained experimentally with the setup shown in FIG. 1 were surprisingly well transferable to the conduit element 60 illustrated in FIG. 7 and that the method with minimized phase angle allowed to achieve a strong reduction both in the formation of bubbles and in particulate introduction.

FIG. 5 and FIG. 6 show two graphs illustrating the results of impedance spectroscopy. In FIG. 5, the absolute value of the complex impedance Z is plotted as a function of frequency. Curve 101 was measured at a melting temperature of 1500° C., curve 102 at a melting temperature of 1400° C., curve 103 at a melting temperature of 1300° C., and curve 104 at a melting temperature of 1200° C.

It can be clearly seen that the absolute value of the impedance passes through a minimum at frequencies between about at least about 2*10² Hz to 5*10² Hz and at most about 1.5*10⁴ Hz to 2*10⁴ Hz, as a function of temperature.

In FIG. 6, the phase angle θ is plotted as a function of frequency. Curve 105 was measured for the same glass at a melting temperature of 1500° C., curve 106 at a melting temperature of 1400° C., curve 107 at a melting temperature of 1300° C., and curve 108 at a melting temperature of 1200° C. Here, too, it can be seen that at these temperatures the phase angle assumes a minimum at frequencies of at least 5*10² Hz to at most 2*10⁴ Hz, i.e. very low values ranging between not more than ±10°, for example at most ±5°, or even at most ±2°.

The results that can be achieved with the method according to the invention are shown in FIG. 10, merely by way of example.

FIG. 10 shows the results of the production of an alkali-free alkaline earth silicate glass with an exemplary composition as specified above, in an exemplary device for making glass products, which is also referred to as a tank, for short.

In this tank, there is a connection between a refining tube and a crucible of the device upstream of or constituting part of the hot forming process, which connection comprises a transfer tube, i.e. the conduit element 60 shown in FIG. 7 and in a further embodiment in FIG. 16. This conduit element 60 was initially heated by three heating circuits referred to as overflow 0 (OF0), overflow 1 (OF1), overflow 2 (OF2). Although FIG. 16 shows heating circuits of overflow 0 (OF0), overflow 1 (OF1) and overflow 2 (OF2) that are arranged one behind the other by way of example, these heating circuits may also be arranged in parallel in the embodiment shown in FIG. 7.

All 3 heating circuits were initially operated using transformers with a tap of 10 V, as substantially corresponding to the diagram in FIG. 7, although only one heating circuit is shown in FIG. 7, by way of example and for the sake of clarity, which provides the voltage U(ω) and the current I(ω), by generator G. This situation is again shown in FIG. 16, in more detail.

The effect of the heating circuits is shown by the corresponding current measurement curves 701, 703, 705, with measurement curve 701 being associated with overflow 2, measurement curve 703 with overflow 1, and measurement curve 705 with overflow 0, and by measurement curves 702, 704, 706 for the electrode potential E (plotted as voltage U), with measurement curve 702 being associated with overflow 2, measurement curve 704 with overflow 1, and measurement curve 706 with overflow 0.

Also by way of example, the number 8 of noble metal comprising particles that were introduced into the molten glass during this time is plotted, namely in the form of square symbols which are not all labeled, for the sake of clarity.

Now, 3 different states can be described:

Time period T1 was about six and a half days.

All three heating circuits were operated using a transformer with a tap of 10 V.

Heating circuit OF0 was operated at an RMS voltage of about 8.2 V, at an RMS current of about 1700 A, and with relatively low phase cutting, however still generated harmonics with frequencies above ω_{y}.

Heating circuit OF1 was operated at an RMS voltage of about 2.9 V, at an RMS current of about 700 A, and with strong phase cutting.

Heating circuit OF2 was operated at an RMS voltage of about 3.1 V, at an RMS current of about 500 A, and with strong phase cutting, which generated harmonics with frequencies above ω_{y} in each case.

FIG. 9 shows an oscilloscope image displaying a voltage curve for overflow 1 during time period T2. Phase cutting is relatively low here.

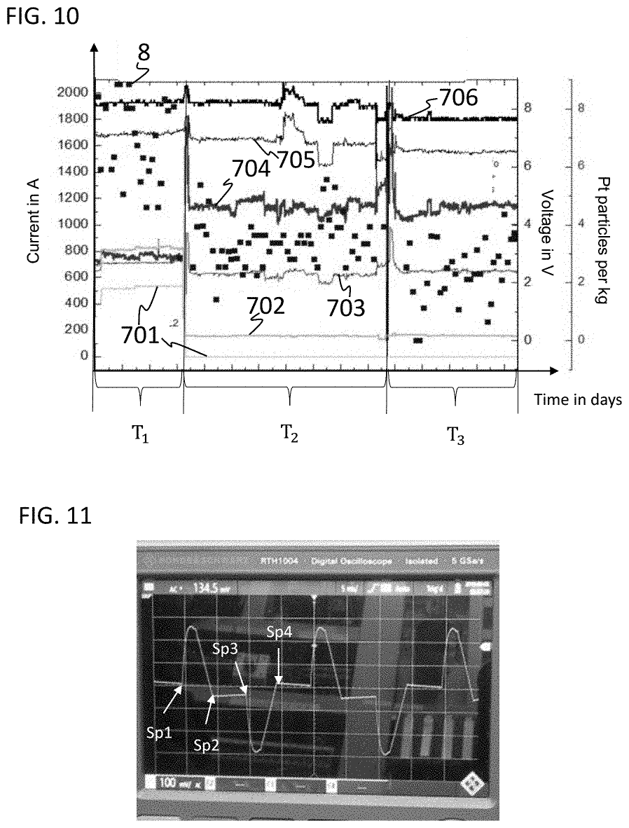

FIG. 11 shows an oscilloscope image displaying a voltage curve for overflow 1 during time period T1. Phase cutting is very pronounced here and therefore has a high proportion of frequencies above ω_{y}. These frequencies arise within a respective full wave of U(ω) at the strongly pronounced voltage jumps Sp1, Sp2, Sp3, and Sp4, which are easily recognizable in FIG. 11. It has also been found that exceeding the frequencies that has been specified as preferred, i.e. ω_{y}, had more detrimental effects than undershooting them.

With the above procedure, the average number of noble metal particles, in particular platinum particles, introduced into the molten glass 2 was approx. 7.0 particles per kg.

Time period T₂ was about 15 days and was consecutive to time period T₁.

Heating circuit OF1 and heating circuit OF2 were merged, so that a new heating circuit (OF1) was obtained.

Both heating circuits were operated using a transformer with a tap with an RMS voltage of 10 V.

Heating circuit OF0 was operated at an RMS voltage of approx. 8.2 V, at an RMS current of approx. 1650 A, and with relatively small phase cutting.

Heating circuit OF1 was operated at an RMS voltage of approx. 4.7 V, at an RMS current of approx. 640 A, and with reduced phase cutting compared to the view of FIG. 11.

With this procedure just described, the average number of noble metal particles introduced into the molten glass 2, in particular platinum particles, was approx. 3.8 particles per kg.

Time period T₃ was about nine and a half days and was consecutive to time period T₂.

Heating circuit OF0 was operated using a variable transformer with an RMS voltage tap of 8 V.

Heating circuit OF1 was operated using a transformer with an RMS voltage tap of 10 V.

Heating circuit OF0 was operated at an RMS voltage of approx. 7.6 V, at an RMS current of approx. 1550 A, and with phase cutting optimized as best as possible, which means that it was smoothed.

The overflow OF1 was operated at an RMS voltage of approx. 4.7 V, at an RMS current of approx. 640 A, and with reduced phase cutting compared to the view of FIG. 11.

The fact that in the operation described above the RMS voltage values were lower than the RMS voltage tap values during time periods T₁ to T₃ represents the normal case of a current-loaded transformer, which can exhibit a decrease in the RMS voltage value as the RMS current value increases.

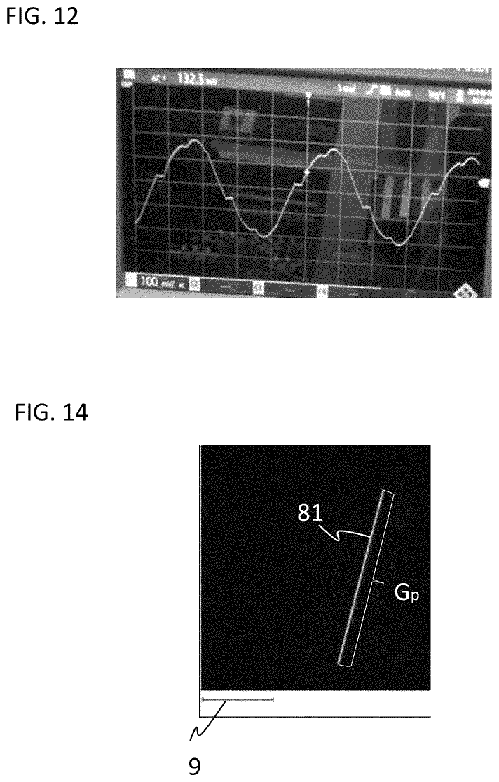

FIG. 12 shows an oscilloscope image displaying a voltage curve for overflow 1 during time period T₃. As can be seen, phase cutting is significantly reduced here compared to the voltage curve shown in FIG. 11, as has been already mentioned above for voltage curves with reduced phase cutting.

With this procedure just described, the average number of noble metal particles introduced into the molten glass 2, in particular platinum particles, was approx. 2.5 particles per kg.

These examples show that a reduced influence of the phase cutting and a more sinusoidal alternating current I(ω) lead to a minimization in particulate introduction into the molten glass 2.

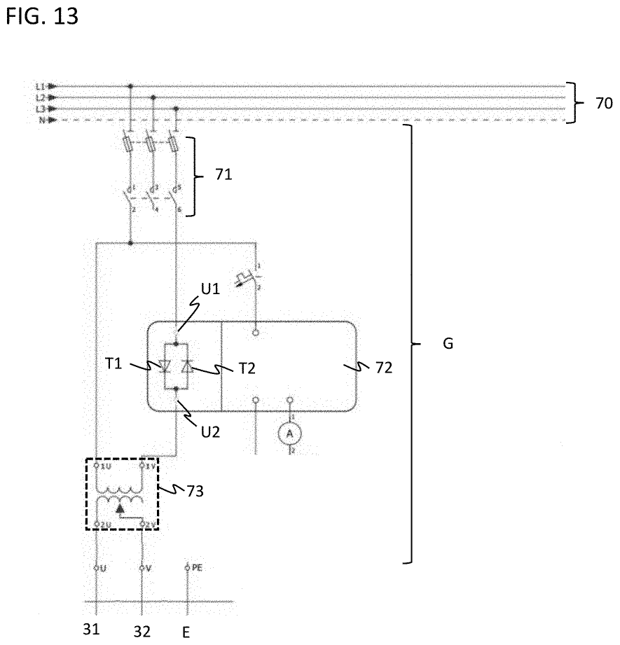

FIG. 13 shows a greatly simplified basic circuit diagram of an exemplary circuit arrangement. Lines L1, L2, L3, and N are lines which in particular carry the phases of a power supply network 70 which may either be part of an internal or of an external power supply network. This power supply network 70 may, for example, provide an alternating voltage with an RMS voltage of 230 V between two respective lines that include the phases L1, L2, L3, at a network frequency of 50 Hz or even higher in the case of an internal power supply network. With this arrangement in which the basic frequency ω₀ was not yet optimally selected, it was already possible to show that the avoidance of harmonics with frequencies ω outside, in particular above the preferred frequency range, had a positive impact in the sense of the stated object of the invention.

Via a fused contactor or protection switch 71, the lines of phases L1 and L3 are routed to the further circuit as will be described in more detail below.

When the contactor 71 is closed, phase L3 is supplied to a parallel circuit comprising the thyristors T1 and T2, and the thyristors T1 and T2 are selectively driven, in particular ignited, by a control circuit 72.

Thyristors T1 and T2 are usually connected between the potentials labeled U1 and U2 in order to generate the phase cutting and to jointly power the variable transformer 73, with the phase-cut phase L3 and with phase L1.

Variable transformer 73 is adapted to transform the voltage generated by thyristors T1 and T2 with phase cutting to a defined low voltage.

The use of such a variable transformer 73 is moreover also an expedient option to equal out, i.e. to smooth, the phase cutting as generated by thyristors T1 and T2.

Variable transformer 73 supplies the voltages and currents described above for the electrodes 31 and 32 also described above, at its connections U and V. The connection denoted PE may be at ground potential E for the grounding of respective assemblies, for example the conduit element or conduit system which is also known as a channel.

The generator G mentioned above is essentially provided by the internal or external power supply network 70, fused contactor or protection switch 71, control circuit 72 and thyristors T1 and T2, and variable transformer 73.

If the power supply network 70 is in the form of an internal power supply network, it may also be operated at other RMS voltages and other basic frequencies ω₀ other than the RMS voltage of 220 V given as an example and other than the alternating voltage with basic frequency ω₀ of 50 Hz given as an example.

These basic frequencies ω₀ can then correspond to the frequencies as shown in FIGS. 5 and 6, for example, in particular in the case of an internal power supply network.

FIG. 14 shows a scanning electron micrograph of an exemplary needle-shaped particle comprising at least one noble metal, which may also be referred to as a noble metal comprising needle. Here, this needle has a maximum lateral dimension of approx. 100 μm, and thus a size Gₚ in the sense of the present disclosure of approx. 100 μm, and the aspect ratio of such needles is typically 100. This means that with a length of about 100 μm, the needle has a width and a depth of only about 1 μm. The scale 9 given in the lower part of FIG. 14 stands for a length of 60 μm.

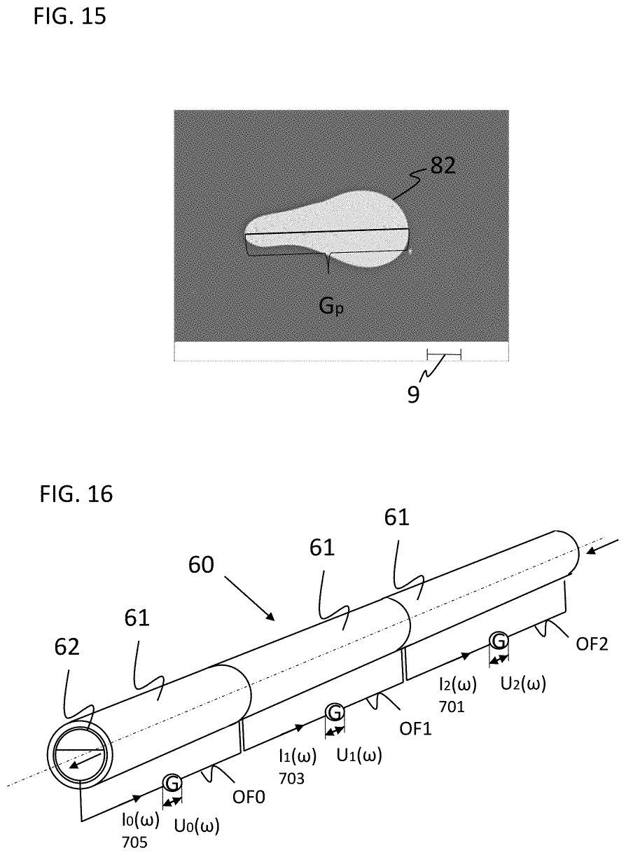

FIG. 15 shows a further scanning electron microscope image of an exemplary particle comprising at least one noble metal with a size Gₚ in the sense of the present disclosure of about 32 μm, which in comparison to the needle of FIG. 14 has a clearly smaller aspect ratio. Despite the deviation of the particle shape from an ideal circular or spherical shape, such particles are still referred to as spherical. The scale given in the lower part of FIG. 15 stands for a length of 10 μm.

### LIST OF REFERENCE SYMBOLS

1 Crucible
2 Molten glass
8 Number of noble metal comprising particles
9 Scale
31, 32 Electrodes
41, 42 Conductors
50 Noble metal comprising crucible
51 Molten glass
52 Reference electrode
53 Working electrode
54 Conductor
60 Conduit element as part of a conduit system
61 Tubular section of 60, made of a refractory material
62 Coating or lining of conduit element 60 comprising at least one noble metal
70 Internal or external power supply network, e.g. with 220 V RMS voltage and an exemplary basic frequency ω₀ of 50 Hz of the alternating voltage
71 Fused contactor or protection switch
72 Control circuit for thyristors T1 and T2
73 Variable transformer
81 Particle in the form of a needle comprising noble metal
82 Spherical particle comprising noble metal
101, 105 Measurement curves for a melting temperature of 1500° C.
102, 106 Measurement curves for a melting temperature of 1400° C.
103, 107 Measurement curves for a melting temperature of 1300° C.
104, 108 Measurement curves for a melting temperature of 1200° C.
701, 703, 705 Current measurement curves
702, 704, 706 Electrode potential measurement curves
F Glass fill level during impedance measurement
G Generator Gₚ Size of noble metal comprising particle
P Direction of currents I(ω) in molten glass 2
Sp1 Voltage jump in a full wave of U(ω)
Sp2 Voltage jump in a full wave of U(ω)
Sp3 Voltage jump in a full wave of U(ω)
Sp4 Voltage jump in a full wave of U(ω)
T1 Thyristor
T2 Thyristor
U1 First potential to which thyristors T1 and T2 are applied
U2 Second potential to which thyristors T1 and T2 are applied
U Connection of the variable transformer to electrode 31
OF0 Heating circuit of overflow 0
OF1 Heating circuit of overflow 1
OF2 Heating circuit of overflow 2
V Connection of the variable transformer to electrode 32
PE Connection to ground potential
E Ground potential for grounding respective assemblies, e.g. the conduit element or conduit system, which is also referred to as a channel
Vw₁ Full wave of a substantially sinusoidal current I(ω)
Hw₁ First half-wave of a substantially non-sinusoidal current I(ω)
Hw₂ Second half-wave of a substantially non-sinusoidal current I(ω)

What is claimed is:

1. A method for producing a glass product, comprising:
conveying a molten silicate glass through a conduit system from one area of a glass product producing installation to another area of the glass product producing installation, wherein the conduit system comprises a noble metal; and
conducting an alternating electric current through the noble metal while conveying the molten silicate glass through the conduit system, the alternating electric current generating Joule heat in the noble metal, wherein the alternating current has a time integral over a positive and a negative half-wave that results in a zero value.

2. The method of claim 1, wherein the conduit system comprises a tubular conduit element and wherein the noble metal is a coating on an inner surface of the tubular conduit element, the alternating current being conducted in a longitudinal direction of the tubular conduit element.

3. The method of claim 1, wherein the alternating current is sinusoidal and has a basic frequency ω₀.

4. The method of claim 3, wherein the basic frequency ω₀ is between at least 2*10² Hz and at most 2*10⁴ Hz.

5. The method of claim 3, wherein the basic frequency ω₀ is between at least 5*10² Hz and at most 1.5*10⁴ Hz.

6. The method of claim 1, wherein the time integral has a deviation over a full wave from an ideal sinusoidal pulse signal curve of less than 10%.

7. The method of claim 1, wherein the time integral has a deviation over a full wave from an ideal sinusoidal pulse signal curve of less than 2%.

8. The method of claim 1, further comprising measuring a phase angle θ₀ between current and voltage at a basic frequency ω₀ at least once.

9. The method of claim 8, further comprising adjusting the basic frequency ω₀ based on the phase angle θ₀ between current and voltage.

10. The method of claim 8, further comprising adjusting the basic frequency ω₀ such that the phase angle θ₀ between current and voltage as a function of frequency is at a local minimum at which a local derivative of the phase angle θ with respect to frequency assumes a zero value.

11. The method of claim 8, wherein the phase angle θ₀ between current and voltage is smaller than ±10°.

12. The method of claim 8, wherein the phase angle θ₀ between current and voltage is smaller than ±2°.

13. The method of claim 1, further comprising generating the alternating electric current I(ω) with a time-dependent profile of a voltage curve U(ω) having signal components with a plurality of discrete frequencies ω₁, ω₂, ω₃, . . . ωₙ, wherein n is a non-zero natural number, and wherein the overall voltage curve U(ω) resulting from the superposition of the individual signal components results as follows:
U(ω)=U₁(ω₁)+U₂(ω₂)+U₃(ω₃)+ . . . Uₙ(ωₙ),
wherein each of U₁(ω₁), U₂(ω₂), U₃(ω₃) . . . Uₙ(ωₙ) is a respective voltage signal with a sinusoidal or cosinusoidal shape with a respective frequency ω₁, ω₂, ω₃, . . . ωₙ;
wherein, each of the discrete frequency components with ω₁, ω₂, ω₃, . . . ωₙ meet the condition that for each of these frequency components with ω₁, ω₂, ω₃, . . . ωₙ the phase angle θ₁(ω₁), θ₂(ω₂), θ₃(ω₃), . . . θₙ(ωₙ) between current and voltage at the respective frequency is less than ±10°.

14. The method of claim 1, further comprising generating the alternating electric current I(ω) with a time-dependent profile of a voltage curve U(ω) having signal components with a continuous spectrum of sinusoidal or cosinusoidal signal components Ui(ωᵢ) with different frequencies ωᵢ from the spectral range or frequency interval from ωₓ to ω_{y}, wherein the following applies for the frequency ωᵢ of each of these signal components:
ωₓ<ωᵢ<ω_{y}
wherein ωₓ is the frequency at which a phase angle θ between current and voltage is −10°, and
wherein ω_{y} the frequency at which a phase angle θ between current and voltage is +10°.

15. The method of claim 1, wherein, during the conveying step, the molten silicate glass has a temperature of between 1000° C. and 1650° C.

16. A glass product, comprising:
a sheet-like glass product of a silicate glass having a thickness of at most 1000 μm and at least 15 μm; and
less than four particles of a noble metal comprising material per kilogram of glass, wherein the less than four particles have a size of less than 200 μm.

17. The glass product of claim 16, further comprising less than three 3 bubbles per kilogram of glass, wherein the less than three bubbles have a size of less than 200 μm.

18. The glass product of claim 16, wherein the silicate glass comprises in wt %:
SiO₂ 50-87; and
Al₂O₃ 0-25 and/or B₂O₃ 5-25.

19. The glass product of claim 16, wherein the silicate glass comprises at most 2500 ppm of SnO₂ based on the weight and/or at least 100 ppm of chloride based on the weight.

20. The glass product of claim 16, wherein the silicate glass comprises at most 2500 ppm of SnO₂ based on the weight and/or at most 2500 ppm of chloride based on the weight.
